(19) United States
(12) Patent Application Publication
(10) Pub. No.: US 2006/0046086 A1
(43) Pub. Date: Mar. 2, 2006

(54) Fakeproof electrocasting plate

(76) Inventors: Chih-Chien Hu, Wufong Township (TW); Kun-Lung Pai, Caotun Township (TW); Yen Hua Huang Chuang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,027

(22) Filed: Aug. 16, 2005

(30) Foreign Application Priority Data
Sep. 1, 2004 (CN) 093213929

(51) Int. Cl. B60J 10/00; B32B 3/30; B22F 5/00

(52) U.S. Cl. 428/573; 428/600; 428/601; 428/687

(57) ABSTRACT

A fakeproof electrocasting plate including a metal main body formed with a figure section. The figure section has at least two different kinds of figures/stripes. The figure section is made through electrocasting procedure by means of a mold treated by hologram. The different kinds of figures/stripes have different reflection angles for reflecting light by different angles. The different kinds of figures/stripes can be seen by different angles to achieve different visual effects so as to provide fakeproof effect for the metal main body.

### BACKGROUND OF THE INVENTION

The present invention is related to a fakeproof electrocasting plate. Figures/stripes are formed on the electrocasting plate by means of laser photography for achieving fakeproof effect.

Figures/stripes 61 can be duplicated on a metal plate 6 by means of photographic duplication or chemical etching. With respect to photographic duplication, the figures/stripes 61 formed on the metal plate 6 are often fogged and monotonous due to poor contrast. With respect to chemical etching, the figures/stripes 61 are relatively clear. However, no fakeproof effect is provided as shown in FIG. 7.

In order to distinguish a true product from a fake one, a fakeproof tab is often attached to the true product for achieving fakeproof effect. The fakeproof tab is generally made of nonmetal material. As a result, the nonmetal-made fakeproof tab tends to be scraped and torn off by an unauthorized person.

### SUMMARY OF THE INVENTION

It is therefore a primary object of the present invention to provide a fakeproof electrocasting plate formed with figures/stripes having different vision angles. When light is projected onto the figures/stripes by different angles, colorful multifold visual effects are achieved to provide fakeproof effect.

According to the above object, the fakeproof electrocasting plate of the present invention includes a metal main body formed with a figure section. The figure section has at least two different kinds of figures/stripes. The figure section is made through electrocasting procedure by means of a mold treated by hologram. The different kinds of figures/stripes have different reflection angles for reflecting light by different angles. The different kinds of figures/stripes can be seen by different angles to achieve different visual effects.

The present invention can be best understood through the following description and accompanying drawings wherein:

### BRIEF DESCRIPTION OF THE DRAWINGS

FIG. 1A is a perspective view of the present invention;

Fig. 1B is a perspective view of the present invention seen in another angle;

FIG. 2 shows the mold core of the present invention;

FIG. 3A shows that laser beam is projected onto the mold core of the present invention;

FIG. 3B is an enlarged view of a part of FIG. 3A;

FIG. 4A shows the electrocasting procedure of the present invention;

FIG. 4B is an enlarged view of a part of FIG. 4A;

FIG. 5 is a flow chart of the processing procedure of the present invention;

FIG. 6 shows that the figures/stripes of the electrocasting plate of the present invention are composed of different reflective stripes with different reflection angles, whereby an observer can see different figures/stripes by different angles; and

FIG. 7 is a perspective view of a conventional electrocasting plate.

### DETAILED DESCRIPTION OF THE PREFERRED EMBODIMENTS

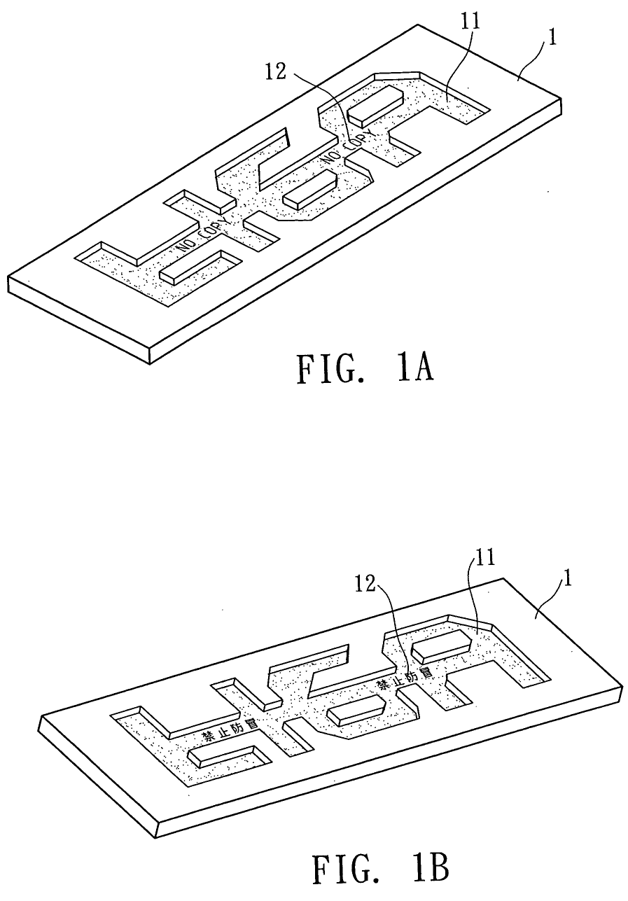

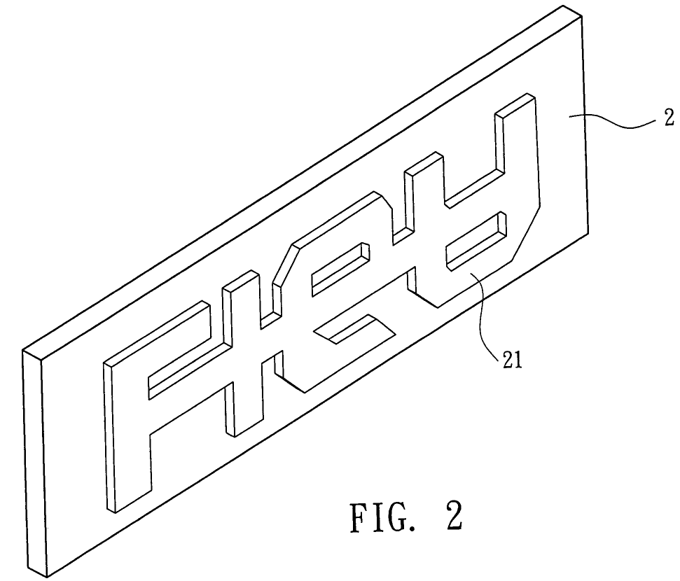

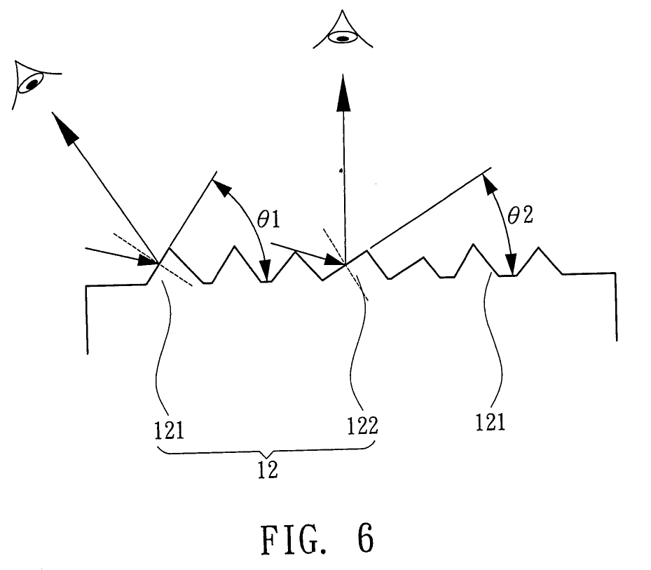

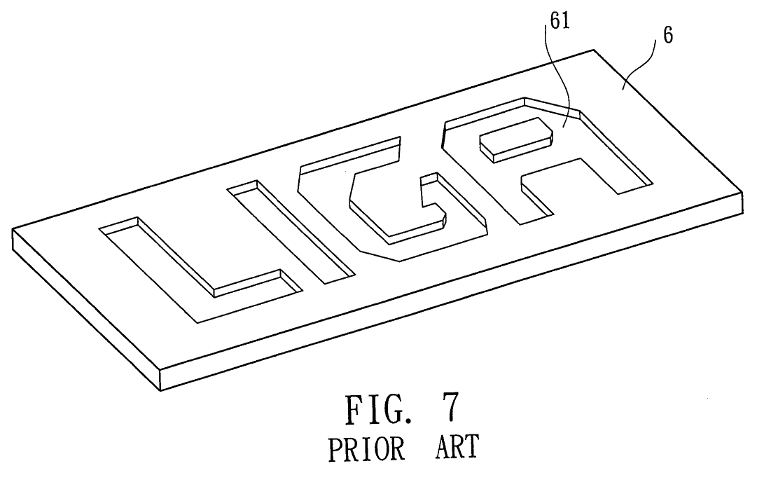

Please refer to FIGS. 1A and 1B. The fakeproof electrocasting plate of the present invention includes a metal main body 1 formed with a figure section 11. In this embodiment, the figure section 11 is made by means of a mold core 2 through electrocasting procedure as shown in FIG. 2. The mold core 2 is embossed with stripes 21 treated by hologram. The figure section 11 has at least two different figures/stripes 12 respectively composed of multiple reflective stripes 121, 122. The reflective stripes 121, 122 have different reflection angles θ1 and θ2 as shown in FIG. 6. In addition, the figures/stripes 12 are formed in the same position and overlap each other so as to achieve a fakeproof effect for the metal main body 1.

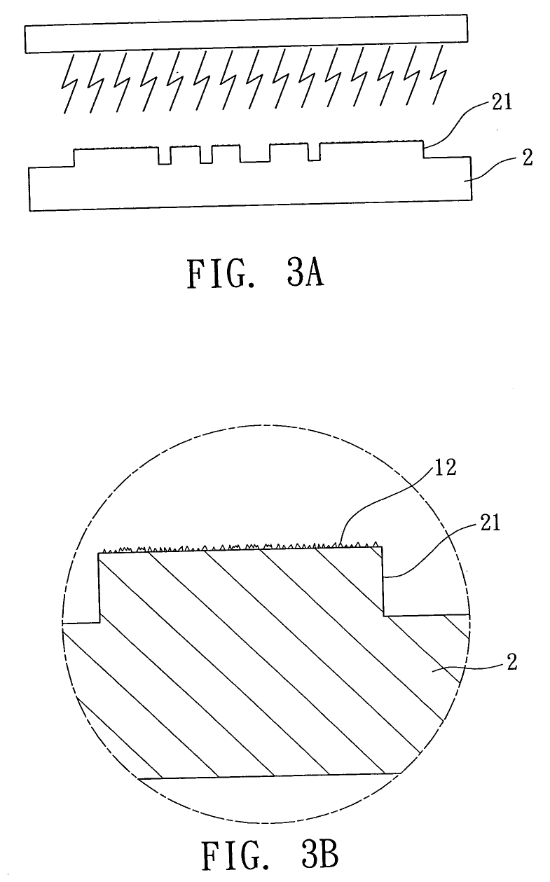

Referring to FIGS. 3A and 3B, the mold core 2 is treated by hologram in such a manner that through light path layout, by means of laser beam with the same wavelength, stripes are left on the negative plate. After developed and fixed, the negative plate is placed on the mold core. Then the laser beam is projected onto the mold core 2 to form the figures/stripes 12 on the surface of the mold core 2.

When the laser beam is projected onto the mold core 2, due to the parameters such as exposure angle, exposure time and wavelength, the figures/stripes 12 of the mold core 2 are variable within a larger range. Therefore, on one hand, an observer can see 2D or 3D figures with flowing effect from the electrocasting plate. The reflective stripes 121, 122 of the figures/stripes 12 have different reflection angles θ1 and θ2. Therefore, the observer can see only one kind of figures/stripes 12 by one angle ( as shown in FIG. 1A). When changing the reflection angle of the electrocasting plate, the observer can see the other kind of figures/stripes 12 (as shown in FIG. 1B). On the other hand, the electrocasting plate is made with invisible fakeproof figures/stripes 12 such as hidden characters and fine characters. Moreover, the angles of the figures/stripes 12 on the mold core 2 will slightly vary. It can be known from Snell refraction law that after light is projected onto the figures/stripes 12 with different angles, colorful multifold visual figures are achieved to provide fakeproof effect.

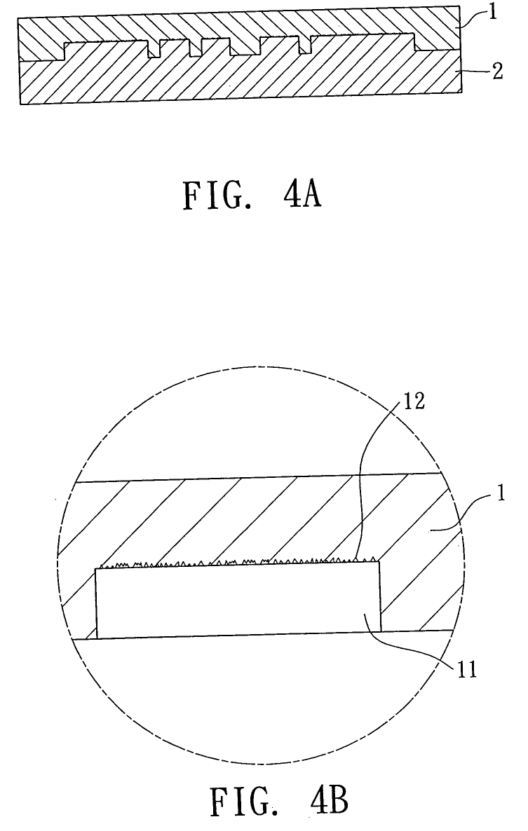

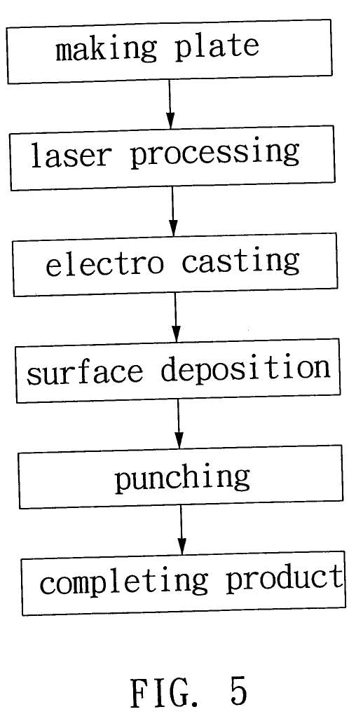

Referring to FIGS. 4A and 4B, by means of the mold core 2, through electrocasting procedure, the electrocasting plate can be integrally formed. By means of surface deposition, the electrocasting plate is prevented from oxidizing. Then by means of punching, an electrocasting plate with fakeproof effect is completed as shown in FIG. 5.

According to the above arrangement, the present invention has the following variations:
1. 2D plane color blocks.
2. 3D solid figures.
3. Flowing effect.
4. Hidden characters and fine characters.
5. Multifold colored solid figures.

By means of the above variations, each figure/stripe 12 is a unique one so as to achieve a fakeproof effect.

The above embodiments are only used to illustrate the present invention, not intended to limit the scope thereof. Many modifications of the above embodiments can be made without departing from the spirit of the present invention.

What is claimed is:

1. A fakeproof electrocasting plate comprising a metal main body formed with a figure section, the figure section having at least two different kinds of figures/stripes, the figure section being made through electrocasting procedure by means of a mold treated by hologram, the different kinds of figures/stripes having different reflection angles for reflecting light by different angles, whereby the different kinds of figures/stripes can be seen by different angles to achieve different visual effects.

2. The fakeproof electrocasting plate as claimed in claim 1, wherein the different kinds of figures/stripes of the figure section are formed in the same position and overlap each other.
